(19) United States
(12) Patent Application Publication
(10) Pub. No.: US 2024/0311742 A1
(43) Pub. Date: Sep. 19, 2024

(54) DEMAND DRIVEN, CONSTRAINT-BASED AND COST OPTIMIZED INBOUND CONTAINER PRIORITIZATION FOR RESILIENT SUPPLY CHAIN

(71) Applicant: Tata Consultancy Services Limited, Mumbai (IN)

(72) Inventors: Ignatius PRADEEP, Chennai (IN); Gaurav JAIN, Thane (West) (IN)

(73) Assignee: Tata Consultancy Services Limited, Mumbai (IN)

(21) Appl. No.: 18/598,228

(22) Filed: Mar. 7, 2024

(30) Foreign Application Priority Data
Mar. 15, 2023 (IN) 202321017459

(51) Int. Cl. G06Q 10/0831; G06Q 10/0832; G06Q 10/087

(52) U.S. Cl. CPC G06Q 10/0831; G06Q 10/0832; G06Q 10/087

(57) ABSTRACT

State of art techniques supply chain management system tend to mostly focus on end to end supply chain management and lose focus on the port of dispatch to retailer segment of supply chain. A method and system for demand driven, constraint-based and cost optimized inbound container prioritization for resilient supply chain is disclosed. Current demand, multiple constraints across destination port, transport carriers, distribution centers, external factors, looks at multiple supply chain cost components like free days, demurrage, transportation, manpower is considered and a ‘n’ week rolling dynamically prioritized list of inbound containers, is generated, which needs to be picked up from the destination port for addressing the volatile customer demand. The dynamic prioritization uses an intelligent ranking algorithm that calculates an urgency score for each container based on crucial parameters before creating a pickup list and helps in maximizing profit while reducing logistic overheads for the retailer.

### PRIORITY CLAIM

This U.S. patent application claims priority under 35 U.S.C. § 119 to: Indian patent application Ser. No. 20/232,1017459, filed on Mar. 15, 2023. The entire contents of the aforementioned application are incorporated herein by reference.

### TECHNICAL FIELD

The embodiments herein generally relate to the field of logistics and supply chain management and, more particularly, to a method and system for inbound container prioritization for resilient supply chain.

### BACKGROUND

Supply chain management is crucial to retail success as it involves planning and controlling the flow of goods from suppliers to delivering it to the end consumer. Retailers may source products domestically or internationally for quality, price variability and profit margins. However, international sourcing needs efficient planning at multiple levels across different legs of supply chain to move products smoothly in the supply chain network.

In general, international logistics encounter significant lead time for supply, primarily due to unforeseen disruptions across transit times, multiple consolidation/deconsolidation points with diverse freight modes and fluctuating costs. Owing to its complexity, suppliers often quote long lead times to offset such disruptions. Most empirical research and academic publications primarily focus on the upstream and downstream aspects of the supply. There is barely any emphasis on container precedence in the supply chain, specifically between containers picked up from an import port to their delivery at the retailer's warehouse.

Today, management of this segment is predominantly driven by manual planning which relies heavily on excel sheets for picking containers on a first-in-first-out basis. It does not consider critical attributes like product demand, availability, lead time, network constraints, etc. This type of planning may result in lost sales as the product in demand may not be picked up on time. Container prioritization would become more effective if these limitations are considered in a way that availability is maximized and at the same time cost is minimized. Therefore, the nature of these impediments advocates a strong case for the involvement of container prioritization that provides transparency in the supply chain and enables improvement in the availability, reliability, and transit times of all modes.

### SUMMARY

Embodiments of the present disclosure present technological improvements as solutions to one or more of the above-mentioned technical problems recognized by the inventors in conventional systems.

For example, in one embodiment, a method for inbound container prioritization for resilient supply chain is provided. The method includes predicting a set of inbound containers arriving at a port of dispatch within a stipulated timeframe for a plurality of products ordered by a retailer. The set of inbound containers comprise a combination of a plurality of Full Container Loads (FCLs) and a plurality of Less than Container Loads (LCLs). Further the method includes dynamically determining individual scores of a plurality of factors impacting container prioritization of the plurality of FCLs for the stipulated timeframe, wherein a container status of each of the plurality of FCLs is one of (i) ready-for-pickup and (ii) not-ready-for-pickup, wherein the plurality of factors comprising: (a) a Port Lead Time factor (PLT_{fact}) scored based on a time required for requesting a carrier to pick up the FCL and time required for the carrier to move from a current location to the port; (b) a Product Demand fulfilment factor (PD_{shortage}) scored based on a demand shortage for each product in the FCL container to determine if a required demand can be met within a buffer time to a warehouse of the retailer, wherein number of products with the demand shortage and a seasonality of the products contribute to value of the PD_{shortage}; (c) a delivery Route Clearance factor (RC_{fact}) scored by validating traffic, weather, and shortest path from the port to a destination set by the retailer using geographic coordinates of the warehouse; (e) a destination Distribution Centre (DC) Dock availability factor (DCD_{fact}) scored by validating congestion at a warehouse docking gate; (f) a destination DC Resource availability factor (DCR_{fact}) scored by predicting absentees among employees for better labor planning and shift allocation at a fulfilment center, machine breakdowns, warehouse outages and capacity constraints; and (g) a destination Port Demurrage cost factor (PDM_{cost}) scored by calculating a dwell time of a container and multiplying by the number of days over and above an agreed free days at the port of dispatch.

Furthermore, the method includes computing a priority score for each of the plurality of FCLs having container status as ready-for-pickup and not-ready-for-pick-up, wherein the priority score is a ratio of integrated individual scores obtained for each the plurality of factors to a total number of FCLs with associated container status. Further the method includes generating a ranking list of the plurality of FCLs in the order of the priority scores with container status ready for pickup followed by not-ready-for-pickup, wherein the ranking list is communicated to the retailer to notify a list of carriers for pick up.

Furthermore, the method includes determining the container prioritization for each of the plurality of Less than Container Loads (LCLs) as a separate entity by: (a) dynamically determining the individual scores of the plurality of factors impacting the container prioritization of the plurality of LCLs for the stipulated timeframe, wherein the container status of each of the plurality of LCLs is one of (i) ready-for-pickup and (ii) not-ready-for-pickup; (b) estimating an additional time taken for deconsolidation of each of the plurality of LCLs at a container freight station (CFS) at the port of dispatch; (c) computing the priority score for each of the plurality of LCLs having container status as ready-for-pickup and not-ready-for-pick-up, wherein the priority score is the ratio of integrated individual scores obtained for each the plurality of factors to a total number of LCLs with associated container status scaled down by the additional time; and (d) ranking the list of plurality of LCLs in the order of the priority scores with container status ready for pickup followed by not-ready-for-pickup.

In another aspect, a system for inbound container prioritization for resilient supply chain is provided. The system comprises a memory storing instructions; one or more Input/Output (I/O) interfaces; and one or more hardware processors coupled to the memory via the one or more I/O interfaces, wherein the one or more hardware processors are configured by the instructions to predict a set of inbound containers arriving at a port of dispatch within a stipulated timeframe for a plurality of products ordered by a retailer. The set of inbound containers comprise a combination of a plurality of Full Container Loads (FCLs) and a plurality of Less than Container Loads (LCLs). Further the system dynamically determines individual scores of a plurality of factors impacting container prioritization of the plurality of FCLs for the stipulated timeframe, wherein a container status of each of the plurality of FCLs is one of (i) ready-for-pickup and (ii) not-ready-for-pickup, wherein the plurality of factors comprising: (a) a Port Lead Time factor (PLT_{fact}) scored based on a time required for requesting a carrier to pick up the FCL and time required for the carrier to move from a current location to the port; (b) a Product Demand fulfilment factor (PD_{shortage}) scored based on a demand shortage for each product in the FCL container to determine if a required demand can be met within a buffer time to a warehouse of the retailer, wherein number of products with the demand shortage and a seasonality of the products contribute to value of the PD_{shortage}; (c) a delivery Route Clearance factor (RC_{fact}) scored by validating traffic, weather, and shortest path from the port to a destination set by the retailer using geographic coordinates of the warehouse; (e) a destination Distribution Centre (DC) Dock availability factor (DCD_{fact}) scored by validating congestion at a warehouse docking gate; (f) a destination DC Resource availability factor (DCR_{fact}) scored by predicting absentees among employees for better labor planning and shift allocation at a fulfilment center, machine breakdowns, warehouse outages and capacity constraints; and (g) a destination Port Demurrage cost factor (PDM_{cost}) scored by calculating a dwell time of a container and multiplying by the number of days over and above an agreed free days at the port of dispatch.

Furthermore, the system computes a priority score for each of the plurality of FCLs having container status as ready-for-pickup and not-ready-for-pick-up, wherein the priority score is a ratio of integrated individual scores obtained for each the plurality of factors to a total number of FCLs with associated container status. Further the system generates a ranking list of the plurality of FCLs in the order of the priority scores with container status ready for pickup followed by not-ready-for-pickup, wherein the ranking list is communicated to the retailer to notify a list of carriers for pick up.

Furthermore, the system determines the container prioritization for each of the plurality of Less than Container Loads (LCLs) as a separate entity by: (a) dynamically determining the individual scores of the plurality of factors impacting the container prioritization of the plurality of LCLs for the stipulated timeframe, wherein the container status of each of the plurality of LCLs is one of (i) ready-for-pickup and (ii) not-ready-for-pickup; (b) estimating an additional time taken for deconsolidation of each of the plurality of LCLs at a container freight station (CFS) at the port of dispatch; (c) computing the priority score for each of the plurality of LCLs having container status as ready-for-pickup and not-ready-for-pick-up, wherein the priority score is the ratio of integrated individual scores obtained for each the plurality of factors to a total number of LCLs with associated container status scaled down by the additional time; and (d) ranking the list of plurality of LCLs in the order of the priority scores with container status ready for pickup followed by not-ready-for-pickup.

In yet another aspect, there are provided one or more non-transitory machine-readable information storage mediums comprising one or more instructions, which when executed by one or more hardware processors causes a method for inbound container prioritization for resilient supply chain.

The method includes predicting a set of inbound containers arriving at a port of dispatch within a stipulated timeframe for a plurality of products ordered by a retailer. The set of inbound containers comprise a combination of a plurality of Full Container Loads (FCLs) and a plurality of Less than Container Loads (LCLs). Further the method includes dynamically determining individual scores of a plurality of factors impacting container prioritization of the plurality of FCLs for the stipulated timeframe, wherein a container status of each of the plurality of FCLs is one of (i) ready-for-pickup and (ii) not-ready-for-pickup, wherein the plurality of factors comprising: (a) a Port Lead Time factor (PLT_{fact}) scored based on a time required for requesting a carrier to pick up the FCL and time required for the carrier to move from a current location to the port; (b) a Product Demand fulfilment factor (PD_{shortage}) scored based on a demand shortage for each product in the FCL container to determine if a required demand can be met within a buffer time to a warehouse of the retailer, wherein number of products with the demand shortage and a seasonality of the products contribute to value of the PD_{shortage}; (c) a delivery Route Clearance factor (RC_{fact}) scored by validating traffic, weather, and shortest path from the port to a destination set by the retailer using geographic coordinates of the warehouse; (e) a destination Distribution Centre (DC) Dock availability factor (DCD_{fact}) scored by validating congestion at a warehouse docking gate; (f) a destination DC Resource availability factor (DCR_{fact}) scored by predicting absentees among employees for better labor planning and shift allocation at a fulfilment center, machine breakdowns, warehouse outages and capacity constraints; and (g) a destination Port Demurrage cost factor (PDM_{cost}) scored by calculating a dwell time of a container and multiplying by the number of days over and above an agreed free days at the port of dispatch.

Furthermore, the method includes computing a priority score for each of the plurality of FCLs having container status as ready-for-pickup and not-ready-for-pick-up, wherein the priority score is a ratio of integrated individual scores obtained for each the plurality of factors to a total number of FCLs with associated container status. Further the method includes generating a ranking list of the plurality of FCLs in the order of the priority scores with container status ready for pickup followed by not-ready-for-pickup, wherein the ranking list is communicated to the retailer to notify a list of carriers for pick up.

Furthermore, the method includes determining the container prioritization for each of the plurality of Less than Container Loads (LCLs) as a separate entity by: (a) dynamically determining the individual scores of the plurality of factors impacting the container prioritization of the plurality of LCLs for the stipulated timeframe, wherein the container status of each of the plurality of LCLs is one of (i) ready-for-pickup and (ii) not-ready-for-pickup; (b) estimating an additional time taken for deconsolidation of each of the plurality of LCLs at a container freight station (CFS) at the port of dispatch; (c) computing the priority score for each of the plurality of LCLs having container status as ready-for-pickup and not-ready-for-pick-up, wherein the priority score is the ratio of integrated individual scores obtained for each the plurality of factors to a total number of LCLs with associated container status scaled down by the additional time; and (d) ranking the list of plurality of LCLs in the order of the priority scores with container status ready for pickup followed by not-ready-for-pickup.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1A depicts a schematic supply chain environment with a system implemented for inbound container prioritization for resilient supply chain between a port of dispatch and a retailer, in accordance with some embodiments of the present disclosure.

FIG. 1B is a functional block diagram of the system for inbound container prioritization for resilient supply chain, in accordance with some embodiments of the present disclosure.

FIG. 2 is a flow diagram illustrating a method for inbound container prioritization for resilient supply chain, using the system of FIG. 1B, in accordance with some embodiments of the present disclosure.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

As mentioned earlier container prioritization is highly beneficial in the sea freight industry as it prioritizes inbound containers in demand to ensure high availability. Unlike domestic procurement, international logistics face several challenges with a prolonged lead time for supply, unreliable transit time, multiple consolidation/deconsolidation points and diverse freight modes with varying costs. The decisions on inbound container pick-up from the destination port are done on a first-come-first-serve basis and do not consider all the crucial variables that would minimize the supply chain costs and consider all network constraints to meet the current demand.

Embodiments of the present disclosure provide a method and system for demand driven, constraint-based and cost optimized inbound container prioritization for resilient supply chain. The inbound containers are interchangeably referred to as containers herein after, The method disclosed provides container prioritization by a complex evaluation process comprising computing of a priority score, which is a based on combination of individual scores computed for a plurality of factors that impact container prioritization. The complex evaluation process in the system prioritizes high-demand containers over others before ranking each container in the order of priority for pickup. The plurality factors used for container prioritization capture the business rules, validation, and predictions to generate a ranking list of containers in the order of priority that warrants adequate inventory to tackle out-of-stock scenarios and reduce supply chain cost by mitigating supply chain risk. The factors include a Port Lead Time factor (PLT_{fact}), a Product Demand fulfilment factor (PD_{shortage}), a delivery Route Clearance factor (RC_{fact}), a destination Distribution Centre (DC) Dock availability factor (DCD_{fact}), a destination DC Resource availability factor (DCR_{fact}) and a destination Port Demurrage cost factor (PDM_{cost}). The container prioritization helps to recover quickly in an occasion of unavoidable delay in the ocean freight supply chain. The ability to validate each product demand and constraints in the container enables improvement in reliability and transit times of all modes.

Thus, the method disclosed takes into consideration the current demand, multiple constraints across destination port, transport carriers, distribution centers, external factors, looks at multiple supply chain cost components like free days, demurrage, transportation, manpower and then generates a ‘n’ week rolling dynamically prioritized list of inbound (import) containers that needs to be picked up from the destination port for addressing the volatile customer demand. The dynamic prioritization uses an intelligent ranking algorithm that calculates an urgency score for each container based on crucial parameters before creating a pickup list and helps in maximizing profit while reducing logistic overheads for the retailer.

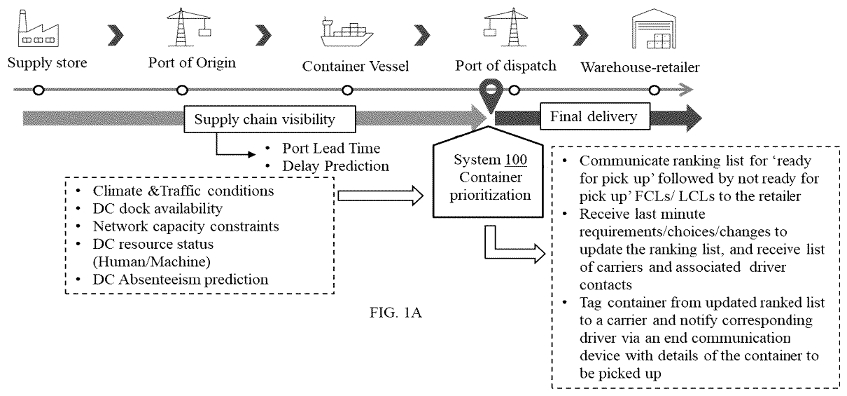

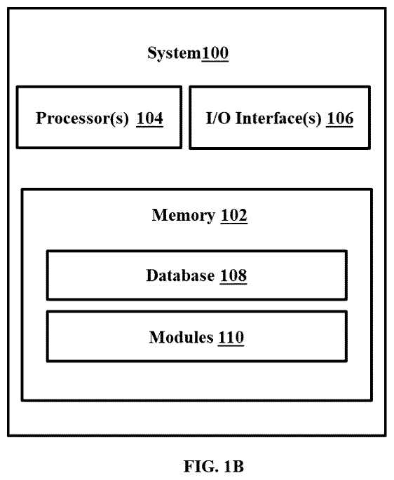

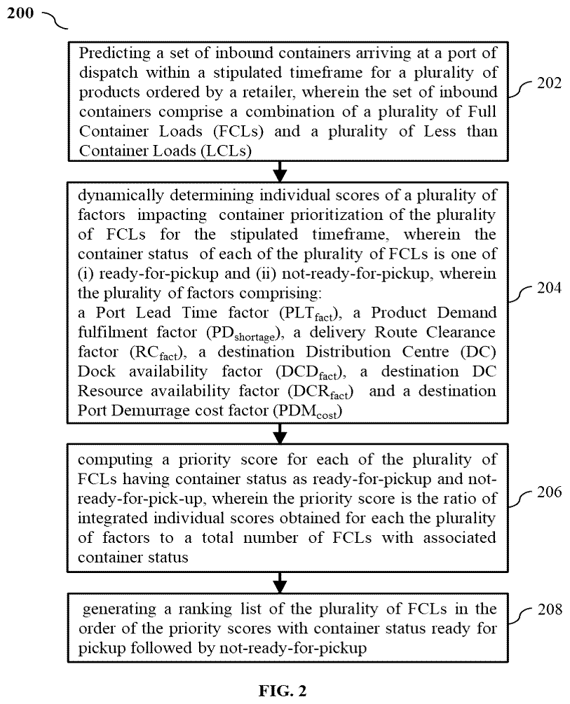

Referring now to the drawings, and more particularly to FIG. 1A through FIG. 2, where similar reference characters denote corresponding features consistently throughout the figures, there are shown preferred embodiments, and these embodiments are described in the context of the following exemplary system and/or method.

FIG. 1A depicts a schematic supply chain environment with a system 100 implemented for inbound container prioritization for resilient supply chain between a port of dispatch and a retailer, in accordance with some embodiments of the present disclosure. An overview of entire supply chain is depicted in FIG. 1 with listing of the major steps provided below with significance of the need for container prioritization, performed by the system 100.
1. Retailer creates the Purchase Order (PO).
2. Supplier reviews the PO and acknowledges the same.
3. Supplier sends an Advanced Shipment Notice (ASN) to the retailer confirming the data & time of dispatch.
4. Assuming supplier owns the export, an agent is notified to prepare legal documents to obtain Letter of Credit or Bill of Lading document.
5. Depending on the type of container, i.e., Full Container Loads (FCLs) and a plurality of Less than Container Loads (LCLs), a carrier is booked to collect the container from the supplier's factory gate.
6. The carrier moves the container to a Container Freight Station in the case of an LCL load, to consolidate the shipments into one full load container according to the destination.
7. If the container is an FCL, the container is directly moved to the shipping yard, awaiting all necessary clearance and shipping time for destination.
8. The agent completes all the paperwork and pays the required export taxes to obtain Bill of Lading document.
9. The agent coordinates with the shipping liner to onboard the container to the ship enroute to the destination. The container is stacked according to the schedule of delivery and in many cases the ship may have more than one transshipment ports for delivery.
10. The shipping liner notifies the container owners when it reaches the anchorage point of the destination while it awaits berth in the port.
11. The ship finally arrives at the port of destination and the retailer's rope in their agents to consume their shipment.
12. Agents coordinate with port authorities to clear customs, pay relevant import taxes and finally be ready to move the container out of the port.
13. Once all the regulatory compliances are met the status of the container becomes ‘Ready-for-Pickup’.
14. At this point, the system 100 receives inputs in accordance with the output of steps 1 to 13 for container prioritization that is executed by the system 100 to meet the customer demands of the retailer. The various static and dynamic factors and parameters are taken into considerations to generate a ranking list of containers for pick up.
15. Communicate ranking list for ‘ready for pick up’ followed by not ready for pick up’ FCLs/LCLs to the retailer
17. Dynamically compute updated ranking list based on last minute requirements/choices/weightages revised by the retailer.
16. Tag the container from the ranking list to a carrier from the carrier list received from the retailer and notify corresponding driver via and end communication device with information of the container to be picked up. However, for any last moment failure of any carrier, the system 100 can identify next in line carrier to continue the task without major glitches. The information of container includes the container location, identification etc.

15. Carrier picks up the goods/freight from tagged container for delivery to the warehouse of the retailer.

FIG. 1B is a functional block diagram of the system 100 for inbound container prioritization for resilient supply chain, in accordance with some embodiments of the present disclosure.

In an embodiment, the system 100 includes a processor(s) 104, communication interface device(s), alternatively referred as input/output (I/O) interface(s) 106, and one or more data storage devices or a memory 102 operatively coupled to the processor(s) 104. The system 100 with one or more hardware processors is configured to execute functions of one or more functional blocks of the system 100.

Referring to the components of system 100, in an embodiment, the processor(s) 104, can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In an embodiment, the system 100 can be implemented in a variety of computing systems including laptop computers, notebooks, hand-held devices such as mobile phones, workstations, mainframe computers, servers, and the like.

The I/O interface(s) 106 can include a variety of software and hardware interfaces, for example, a web interface, a graphical user interface to display the generated target images and the like and can facilitate multiple communications within a wide variety of networks N/W and protocol types, including wired networks, for example, LAN, cable, etc., and wireless networks, such as WLAN, cellular and the like. In an embodiment, the I/O interface (s) 106 can include one or more ports for connecting to a number of external devices or to another server or devices.

The memory 102 may include any computer-readable medium known in the art including, for example, volatile memory, such as static random-access memory (SRAM) and dynamic random access memory (DRAM), and/or non-volatile memory, such as read only memory (ROM), erasable programmable ROM, flash memories, hard disks, optical disks, and magnetic tapes.

In an embodiment, the memory 102 includes a plurality of modules 110 (not shown) to gather or extract data from external or internal resources and process the gathered data for computing priority score for each container, further generate the ranking list of the containers. Example modules along with corresponding functions are listed below.
a) Spotting Agent: This component helps in locating a purchase order/container product in the supply chain through interactive visual route maps and pop-up reports on specific ports enroute the destination. The information can be sourced in multiple ways, for e.g.: If the carrier has a GPS device on the container or if the carrier has an ELD (Electronic Logging Devices) devices on the container. The spotting agent feeds the current location coordinates to compute lead time prediction.
b) Open Weather Agent: This component helps in identifying climatic disruptions by utilizing the container Location to automatically scale temperature and weather to ensure that the uncertainties are reported. This agent assist the container status prediction by feeding in disruptions data. If there are any disruptions like a storm in the ocean, then the delay is fed back to the lead time prediction algorithm to factor the delay caused by nature.
c) Google Traffic Agent: This component helps in geo-locating a container in the road either through the utilization of GPS receiver or by manually feeding the coordinates of the truck. This agent assists in predicting the lead time from the port of dispatch/destination to the final warehouse (retailer end). Demand Sensing Agent: This component imports the four-day rolling and four-week rolling demand planning and sales forecast generated by the retailer's inventory replenishment systems. The demand data is used in calculating the demand gap which is the key in container prioritization.
d) Inventory Tracking Agent: This component connects in near real-time with the retailer's inventory system to track on-shelf availability at the relevant warehouses. This data is then fed into the container prioritization for calculating demand gap along with demand forecast data.
e) Cost Manager: This component calculates the variable cost involved in the supply chain by integrating actuals from the retailer's Enterprise resource planning (ERP) systems. It also factors the external time sensitive costs such as demurrage and detention charges. The input data can also be sourced directly from the shipping port depending on the availability. This data is fed into for the container prioritization computation and is a key factor in determining the priority score of each container.
f) Master Data Integrator: This component integrates the product, location, supplier, and other essential master data from the retailer's systems once a day. This input data contains product characteristics information like seasonality, perishability, and product cost details. The information is used in the container prioritization to validate the shelf life of the product. This information enables perishable products to be prioritized above normal products and is a contributing factor while computing demand of the product as can be understood by person having ordinary skill in the art.

The plurality of modules 110 include programs or coded instructions that supplement applications or functions performed by the system 100 for executing different steps involved in the process of container prioritization, being performed by the system 100. The plurality of modules 110, amongst other things, can include routines, programs, objects, components, and data structures, which performs particular tasks or implement particular abstract data types. The plurality of modules 110 may also be used as, signal processor(s), node machine(s), logic circuitries, and/or any other device or component that manipulates signals based on operational instructions. Further, the plurality of modules 110 can be used by hardware, by computer-readable instructions executed by the one or more hardware processors 104, or by a combination thereof. The plurality of modules 110 can include various sub-modules (not shown).

Further, the memory 102 may comprise information pertaining to input(s)/output(s) of each step performed by the processor(s) 104 of the system 100 and methods of the present disclosure. Further, the memory 102 includes a database 108. The database (or repository) 108 may include a plurality of abstracted piece of code for refinement and data that is processed, received, or generated as a result of the execution of the plurality of modules in the module(s) 110 such as the individual scores, and the priority score for each container, the raking list and so on.

Although the database 108 is shown internal to the system 100, it will be noted that, in alternate embodiments, the database 108 can also be implemented external to the system 100, and communicatively coupled to the system 100. The data contained within such external database may be periodically updated. For example, new data may be added into the database (not shown in FIG. 1) and/or existing data may be modified and/or non-useful data may be deleted from the database. In one example, the data may be stored in an external system, such as a Lightweight Directory Access Protocol (LDAP) directory and a Relational Database Management System (RDBMS). Functions of the components of the system 100 are now explained with reference to steps in flow diagram in FIG. 2.

FIG. 2 is a flow diagram illustrating a method 200 for inbound container prioritization for resilient supply chain, using the system of FIG. 1B, in accordance with some embodiments of the present disclosure.

In an embodiment, the system 100 comprises one or more data storage devices or the memory 102 operatively coupled to the processor(s) 104 and is configured to store instructions for execution of steps of the method 200 by the processor(s) or one or more hardware processors 104. The steps of the method 200 of the present disclosure will now be explained with reference to the components or blocks of the system 100 as depicted in FIG. 1B and the steps of flow diagram as depicted in FIG. 2. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

Referring to the steps of the method 200, at step 202 of the method 200, the one or more hardware processors 104 predict a set of inbound containers arriving at a port of dispatch within a stipulated timeframe for a plurality of products ordered by a retailer. The set inbound containers comprise a combination of a plurality of Full Container Loads (FCLs) and a plurality of Less than Container Loads (LCLs). Prediction of the set of inbound containers arriving at the port of dispatch within the stipulated timeframe is based on a plurality of parameters in the supply chain from a time a product order is picked up from a supplier factory gate to a time the product order reaches the port of dispatch. This can be performed by the intelligent container prioritization module.

As well-known in the art FCL means that a shipment occupies the entire space of a container, without having to share it with other shippers or retailers. In an FCL cargo, the complete goods in the container are owned by one shipper or retailer. Thus, prioritizing FCLs is less complex. However, LCL refers to transportation of small ocean-freight shipments, which do not require the full capacity of a container. This is why an LCL container is also called a ‘consolidated container’. LCL is a flexible and cost-effective option for transporting smaller, less time-critical shipments between the world's major ports. Thus, it is clear the LCL has multiple products of multiple retailers.

At step 204 of the method 200, the one or more hardware processors 104 dynamically determine individual scores of the plurality of factors impacting container prioritization of the plurality of FCLs for the stipulated timeframe. The container status of each of the plurality of FCLs is one of (i) ready-for-pickup and (ii) not-ready-for-pickup. The method disclosed considers the LCLs as a separate entity follows same process as applied for score computation for FCLs. However, for LCLs one more factor referring to an additional time is computed, which refers to time taken for deconsolidation of each of the plurality of LCLs at a container freight station (CFS) at the port of dispatch.

The plurality of factors and corresponding individual score computation is described below in steps (a) though (f). Computation of the individual score for each of the plurality of factors is based on one or more of a plurality of parameters that are either computed, derived, or obtained from various external/internal resources. The definitions of the plurality of parameters are mentioned below.

TABLE 1
Parameters-set 1 and definitions

| Order ID | Number Of purchase orders in the container |
|---|---|
| Item ID | Each unique product number in each container |
| | retrieved from the purchase order. |
| Container | The status of the container if its ‘Ready for pickup’ |
| Status | or ‘not ready for pick up’ |
| Port Lead | Port Lead time is the amount of time that passes |
| Time | from the start of the container from the supplier's |
| (PLT) | factory gate to the time it reaches the port of |
| | dispatch. |
| Last-Mile | Last-Mile lead time is the amount of time that |
| Lead Time | passes from the start of the container from the port |
| (LMLT) | of dispatch to the time it reaches the retailer's |
| | warehouse. |
| Product | The actual demand of the product as sourced from |
| Demand | the retailers ERP systems in a 4-day rolling and 28 |
| (PD) | day forecast format. |
| Route | The validation of roadblocks, geo-political |
| Clearance | hindrance, climatic challenges, and traffic |
| (RC) | congestion enroute the final destination. |
| Last-Mile Source | The port of dispatch from where the container needs |
| Port (LMS) | to be picked up. |
| Last-Mile | The retailer's warehouse to which the container |
| Destination | needs to be delivered. |
| Distribution | |
| Centre | |
| (DC) (LMD) | |
| Destination | The validation of congestion at the retailer's |
| Distribution | warehouse and docking gate. |
| Centre (DC) | |
| Docking Status | |
| (DC_DOCK_STS) | |
| Destination DC | The evaluation of the availability of the DC |
| Resource | resources to which the container is delivered |
| Availability | |
| (DC_RES) | |
| Destination Port | Demurrage Charges - A tariff charged for containers |
| Demurrage | and goods being housed/stored for a longer period |
| Charges | at the port yard. |
| Detention | Detention Charges - A late fee charged for |
| Charges | containers that are returned late to their owners. |

TABLE 2
Acronyms used in sea freight supply chain

| Acronym | Description |
|---|---|
| CP | Container Prioritization |
| CFS | Container Freight Station |
| COC | Carrier Owned Container |
| DC | Distribution Centre |
| Incoterms | International Commercial Terms |
| EXW | Ex-Works |
| FCA | Free Carrier Agreement |
| FOB | Free/Freight on Board |
| CNF | Cost Net Freight |
| CIF | Cost Insurance and Freight |
| DAT | Delivered At Terminal |
| DAP | Delivered At Place |
| LCL | Less than Container Load |
| FCL | Full Container Load |
| CY | Container Yard |
| Demurrage | A tariff charged for containers and goods being |
| | housed/stored for a longer period |
| Detention | A late fee charged for containers that are returned |
| | late to their owners |
| Bill of | This is the contract between the goods owner and |
| Lading | the shipping company |
| Freight | The transportation of a shipping container, the |
| Forwarder | paperwork, customs clearances and securing cargo |
| | space is handled by the freight forwarder |
| TEU | “Twenty Foot Equivalent Unit” - Standard twenty-foot |
| | shipping container |
| THC | Terminal Handling Charge |
| Transhipment | Containers are exchanged from one vessel to |
| | another to continue their journey to their port of |
| | destination |
| ETA | Expected Time of Arrival |
| ETD | Expected Time of Dispatch |
| Landed | Landed cost is the total cost of a shipment when it |
| Cost | has arrived at its destination. |
| Per diem | fee that is charged when a user exceeds the number |
| | of free days agreed upon. The fee is often calculated |
| | per day. |
| Reefer | A ‘reefer’ is a refrigerated container. A reefer can be |
| | used for temperature-sensitive shipments. |

### Parameters-Set 2 (Variables) with Definitions

CONT_{Status}=The status of the container (E.g.: ‘Ready for Pickup’ or ‘not-ready-for-pick-up, e.g., Awaiting Customs’, etc.). Ready for Pickup status can be obtained by the feed from the carrier or from the retailer's customs agent. All the containers that do not fall under ‘ready to pick up’ status can be tagged as ‘Not ready for pickup.’ Similarly, regression based Artificial Intelligence models, well known in the art are trained based on features associated with container status to predict containers that will not be ready for pick up.
PLT_{Fact}=The cost incurred in the time taken for the inbound container to reach the port of dispatch (also referred to as port) and the time for a carrier planned by a retailer (for example, a truck) to reach the port for pickup of goods or products shipped in the container.
PLT_{DelayRFO}=Weight of importance (assigned weight indicating the importance or significance identified for a specific parameter), herein in calculating port lead time for ‘Ready for Pickup’ containers. All weights in the set 2 are determined by the retailer or end user based on importance he/she intends to provide to a specific parameter based on individual business requirements.
PLT_{Delay}=Weight of importance in calculating port lead time for not ‘Ready for Pickup’ containers.
SPLT_{Time}=Supplier Manufacturing Lead time in days
SPWLT_{Time}=Supplier agent customs lead time at Port of Loading in days
MLT_{Time}=Total time of container in the ocean in days
CULT_{Time}=Retailer's agent customs lead time at Port of despatch in days
CLT_{Time}=Container dwell time at the port of despatch in days
PD_{Shortage}=The cost incurred in prioritising the container with the highest demand
DC_{Demand}=The aggregated sum of DC demand (for DC Lead time) for each product in the container
DC_{OH}=The aggregated sum of DC on-hand for each product at the destinated warehouse
CONT_{OH}=The aggregated sum of Container on-hand for each product
PDC_{SurgeRFO}=Weight of importance in calculating the product demand for ‘Ready for Pickup’ containers which can fulfil the DC demand in surplus
PDC_{DeficientRFO}=Weight of importance in calculating the product demand for ‘Ready for Pickup’ containers which cannot fulfil the DC demand in surplus. Needs higher priority.
PDC_{Surge}=Weight of importance in calculating the product demand for NOT ‘Ready for Pickup’ containers which can fulfil the DC demand in surplus
PDC_{Deficient}=Weight of importance in calculating the product demand for NOT ‘Ready for Pickup’ containers which cannot fulfil the DC demand in surplus. Needs higher priority.
RC_{Fact}=Cost incurred in forecasting potential delays in outbound due to predicted traffic disruptions and weather catastrophe.
DLT_{TIME}=Time taken by the carrier in hours from source to destination.
OR_{Status}=Status of the Outbound Route retrieved from Google APIs to identify traffic congestions. Status received on a scale of 5 with 1 being least impactful and 5 being very high impact.
OR_{Weather}=Status of the Outbound Route retrieved from Google APIs to identify weather predictions. Status received on a scale of 5 with 1 being least impactful and 5 being very high impact.
RC_{WeightRFO}=Weight of importance in calculating route clearance for OTIFs of containers that are ‘Ready for Pickup.’
RC_{Weight}=Weight of importance in calculating route clearance for OTIFs of containers that are not ‘Ready for Pickup.’
DCD_{Fact}=Cost incurred in calculating the status of DC dock availability.
DCD_{Weight}=Weight of importance in calculating DC dock status.
DCR_{Fact}=Cost incurred in calculating the status of DC Resource availability.
DCR_{Weight}=Weight of importance in calculating DC resource availability.
CONT_{ArrivalDate}=The date on which the container arrived at the port of despatch.
FREE_{Days}=The total free days allowed at the port of despatch
PDM_{Cost}=Cost incurred in calculating the demurrage charges for eligible containers.
PDM_{Weight}=Weight of importance in calculating the demurrage cost
Thresh_{PDM}=Threshold limit in days for containers that are about to breach the FREEDays mark.

### Example Value Assumptions of few Constants from Above set of Parameters

TABLE 3

| | Proposed |
|---|---|
| Variable | Values |
| PLT_{DelayRFO} | 100 |
| PLT_{Delay} | 0.001 |
| PDC_{SurgeRFO} | 200 |
| PDC_{DeficientRFO} | 400 |
| PDC_{Surge} | −150 |
| PDC_{Deficient} | −300 |
| RC_{WeightRFO} | 50 |
| RC_{Weight} | −25 |
| DCD_{Weight} | 100 |
| DCR_{Weight} | 100 |
| FREE_{Days} | Varies by Port |
| PDM_{Weight} | 0.01 |
| Thresh_{PDM} | FREE_{Days} − 2 |
| | Days |

### The Plurality of Factors and Computation:

a) The Port Lead Time factor (PLT_{fact}) is scored based on a time required for requesting a carrier to pick up a FCL and time required for the carrier to move from a current location to the port.

### Computation of Port Lead Time Factor:

If CONT_{Status}=‘Ready for Pickup’:
PLT_{Fact}=(Time required for requesting carrier to pick up a container+Time required for carrier to move from their location to container port) * PLT_{DelayRFO}
Else
PLT_{WaitTime}=(Time required for requesting carrier to pick up a container+Time required for carrier to move from their location to container port)

$$\begin{matrix}PL {T}_{T i m e} = S P L {T}_{T i m e} + S P W L {T}_{T i m e} + M L {T}_{T i m e} + {CULT}_{T i m e} + C L {T}_{T i m e} \\ {PLT}_{F a c t} = ( PL {T}_{T i m e} + P L {T}_{W a i t T i m e} ) * {PLT}_{Delay}^{*} - 1\end{matrix}$$

b) The Product Demand fulfilment factor (PD_{shortage}) is scored based on a demand shortage for each product in the FCL container to determine if a required demand can be met within a buffer time to a warehouse of the retailer, wherein number of products with the demand shortage and a seasonality of the products contribute to value of the PD_{shortage}.

### Computation of Product Demand Fulfilment Factor

If CONT_{Status}=‘Ready for Pickup’:
   For each product in the container
      If DC_{Demand}−DC_{OH}>0

$${PD}_{Shortage} = \frac{\# of products with shortage}{\# of products in the container} ⋆ 75 \% + \frac{Shortage}{D e m a n d} * 25 \%$$

If Product_Type=‘Seasonal’ and ‘Start of Season’
   PD_{Shortage}=PD_{Shortage}+1
If Shortage<CONT_{OH}
   PD_{Shortage}=PD_{Shortage} * PDC_{SurgeRFO}
Else
   Since shortage is more than the current on hand of the container more priority is given
      PD_{Shortage}=PD_{Shortage} * PDC_{DeficientRFO}
Else
   For each product in the container
      If DC_{Demand}−DC_{OH}>0

$${PD}_{Shortage} = \frac{\# of products with shortage}{\# of products in the container} ⋆ 75 \% + \frac{Shortage}{D e m a n d} * 25 \%$$

If Product_Type=‘Seasonal’ and ‘Start of Season’
   PD_{Shortage}=PD_{Shortage}+1
If Shortage<CONT_{OH}
   PD_{Shortage}=PD_{Shortage} * PDC_{Surge} * −1
Else
   PD_{Shortage}=PD_{Shortage} * PDC_{Deficient} * −1
c) The delivery Route Clearance factor (RCfact) is scored by validating traffic, weather, and shortest path from the port to a destination set by the retailer using geographic coordinates of the warehouse.

### Computation of Delivery Route Clearance Factor

If CONT_{Status}=‘Ready for Pickup’:

$${RC}_{F a c t} = ( {DLT}_{TIME} + {OR}_{Status} + O {R}_{W e a t h e r} ) * {RC}_{WeightRFO}$$

Else

$${RC}_{F a c t} = ( DL {T}_{TIME} + {OR}_{Status} + O {R}_{W e a t h e r} ) * {RC}_{Weight}^{*} - 1$$

d) The destination Distribution Centre (DC) Dock availability factor (DCDfact) is scored by validating the congestion at the warehouse docking gate.

### Computation of Destination DC Dock Availability Factor

If CONT_{Status}=‘Ready for Pickup’
   If DC_DOCK_STS=‘Available’:
      DCD_{Fact}=1 * DCD_{Weight}
   Else
      DCD_{Fact}=0
Else
   If DC_DOCK_STS Not=‘Available’:
      DCD_{Fact}=−1 * DCD_{Weight}
   Else
      DCD_{Fact}=0
e) The destination DC Resource availability factor (DCRfact) is scored by predicting absentees among employees for better labor planning and shift allocation at a fulfilment center, machine breakdowns, warehouse outages and capacity constraints.

### Computation of Destination DC Resource Availability Factor

If CONT_{Status}=‘Ready for Pickup’
   If DC_RES=‘Available’:
      DCR_{Fact}=1 * DCR_{Weight}
   Else
      DCR_{Fact}=0
Else
   If DC_RES=‘Available’:
      DCR_{Fact}=−1 * DCR_{Weight}
   Else
      DCR_{Fact}=0
f) The destination Port Demurrage cost factor (PDMcost) is scored by calculating a dwell time of a container and multiplying by the number of days over and above the agreed free days at the port of dispatch.

### Computation of Destination Port Demurrage Cost

If CONT_{Status}=‘Ready for Pickup’
   If CURR_{Date}−CONT_{ArrivalDate}>FREE_{Days}
      PDM_{Cost}=((CURR_{Date}−CONT_{ArrivalDate}) * DEMM_COST)/PDM_{Weight}
   Else
      If CURR_{Date}−CONT_{ArrivalDate}>Thresh_{PDM}
         PDM_{cost}=(CURR_{Date}−CONT_{ArrivalDate}) * DEMM_COST)/PDM_{ThreshWeight}
      Else
         PDM_{Cost}=0.
Else
   PDM_{Cost}=0.

Upon computation of the individual scores, at step 206 of the method 200, the one or more hardware processors 104 compute a priority score for each of the plurality of FCLs having container status as ready-for-pickup and not-ready-for-pick-up. The priority score is the ratio of integrated individual scores obtained for each the plurality of factors to a total number of FCLs with associated container status. A total or sum of individual scores for each container (FCL and LCL) is as in equation below.

$$Integrated individual scores ( Total ) = {PLT}_{Fact} + {PD}_{Shortage} + {RC}_{Fact} + {DCD}_{Fact} + {DCR}_{Fact} + {PDM}_{Cost}$$

Priority Score=Total/Number of Containers to prioritize (FCLs or LCLs based on for which type of containers the priority score is being computed).

Thereafter, at step 208 of the method 200, the one or more hardware processors 104 generate the ranking list of the plurality of FCLs in the order of the priority scores with container status ready for pickup followed by not-ready-for-pickup. Similar process is followed for LCLs.

Upon generation of the ranking list, in one example implementation, the system 100 then communicates ranking list of ‘ready for pick up’ followed by not ready for pick up' FCLs/LCLs to the retailer. Further, the system 100 recomputes updated ranking list based on last minute requirements/choices/weightages revised by the retailer. The system 100 also receives list of carriers and associated driver contacts. Thereafter, the system 100 tags the container from the ranking list to a carrier from the carrier list and notifies corresponding driver via an end communication device such as mobile device with information of the container to be picked up, such as container identification, location and so on. However, for any last moment failure of any carrier, the system 100 can identify next in line carrier to continue the task without major glitches. Once container details are received, the carrier picks up the goods/freight from tagged container for delivery to the warehouse of the retailer.

As mentioned, container prioritization for each of the plurality of Less than Container Loads (LCLs) is considered as a separate entity with priority score computation logic remaining the same as for FCLs. The steps comprising:
a) Dynamically determining the individual scores of the plurality of factors impacting the container prioritization of the plurality of LCLs for the stipulated timeframe. The container status of each of the plurality of LCLs is one of (i) ready-for-pickup and (ii) not-ready-for-pickup.
b) Estimating an additional time taken for deconsolidation of each of the plurality of LCLs at a container freight station (CFS) at the port of dispatch.
c) Computing the priority score for each of the plurality of LCLs having container status as ready-for-pickup and not-ready-for-pick-up. The priority score is the ratio of integrated individual scores obtained for each the plurality of factors to a total number of LCLs with associated container status scaled down by the additional time.
d) Ranking the list of plurality of LCLs in the order of the priority scores with container status ready for pickup followed by not-ready-for-pickup. Similar to FCLs the ranking list for LCLs is also shared with a carrier to prioritize a LCL.

Thus, the method and system disclosed herein provides a demand driven, constraint-based and cost optimized inbound container prioritization for resilient supply chain.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for container prioritization in supply chain, the method comprising:
predicting via one or more hardware processors, a set of inbound containers arriving at a port of dispatch within a stipulated timeframe for a plurality of products ordered by a retailer, wherein the set of inbound containers comprise a combination of a plurality of Full Container Loads (FCLs) and a plurality of Less than Container Loads (LCLs);
dynamically determining via the one or more hardware processors, individual scores of a plurality of factors impacting container prioritization of the plurality of FCLs for the stipulated timeframe, wherein a container status of each of the plurality of FCLs is one of (i) ready-for-pickup and (ii) not-ready-for-pickup, wherein the plurality of factors comprising:
a Port Lead Time factor (PLT_{fact}) scored based on a time required for requesting a carrier to pick up the FCL and time required for the carrier to move from a current location to the port;
a Product Demand fulfilment factor (PD_{shortage}) scored based on a demand shortage for each product in the FCL container to determine if a required demand can be met within a buffer time to a warehouse of the retailer, wherein number of products with the demand shortage and a seasonality of the products contribute to value of the PD_{shortage};
a delivery Route Clearance factor (RCfact) scored by validating traffic, weather, and shortest path from the port to a destination set by the retailer using geographic coordinates of the warehouse;
a destination Distribution Centre (DC) Dock availability factor (DCD_{fact}) scored by validating congestion at a warehouse docking gate;
a destination DC Resource availability factor (DCR_{fact}) scored by predicting absentees among employees for better labor planning and shift allocation at a fulfilment center, machine breakdowns, warehouse outages and capacity constraints; and
a destination Port Demurrage cost factor (PDM_{cost}) scored by calculating a dwell time of a container and multiplying by the number of days over and above an agreed free days at the port of dispatch;
computing via the one or more hardware processors, a priority score for each of the plurality of FCLs having container status as ready-for-pickup and not-ready-for-pick-up, wherein the priority score is a ratio of integrated individual scores obtained for each the plurality of factors to a total number of FCLs with associated container status; and
generating via the one or more hardware processors, a ranking list of the plurality of FCLs in the order of the priority scores with container status ready for pickup followed by not-ready-for-pickup, wherein the ranking list is communicated to the retailer to notify a list of carriers for pick up.

2. The processor implemented method as claimed in claim 1, wherein determining the container prioritization for each of the plurality of Less than Container Loads (LCLs) as a separate entity, comprising:
dynamically determining the individual scores of the plurality of factors impacting the container prioritization of the plurality of LCLs for the stipulated timeframe, wherein the container status of each of the plurality of LCLs is one of (i) ready-for-pickup and (ii) not-ready-for-pickup;
estimating an additional time taken for deconsolidation of each of the plurality of LCLs at a container freight station (CFS) at the port of dispatch;
computing the priority score for each of the plurality of LCLs having container status as ready-for-pickup and not-ready-for-pick-up, wherein the priority score is the ratio of integrated individual scores obtained for each the plurality of factors to a total number of LCLs with associated container status scaled down by the additional time; and
ranking the list of plurality of LCLs in the order of the priority scores with container status ready for pickup followed by not-ready-for-pickup.

3. The processor implemented method as claimed in claim 1, wherein predicting the set of inbound containers arriving at the port of dispatch within the stipulated timeframe is based on a plurality of parameters in the supply chain from a time a product order is picked up from a supplier factory gate to a time the product order reaches the port of dispatch.

4. A system for container prioritization in supply chain, the system comprising:
a memory storing instructions;
one or more Input/Output (I/O) interfaces; and
one or more hardware processors coupled to the memory via the one or more I/O interfaces , wherein the one or more hardware processors are configured by the instructions to:
predict a set of inbound containers arriving at a port of dispatch within a stipulated timeframe for a plurality of products ordered by a retailer, wherein the set of inbound containers comprise a combination of a plurality of Full Container Loads (FCLs) and a plurality of Less than Container Loads (LCLs);
dynamically determine individual scores of a plurality of factors impacting container prioritization of the plurality of FCLs for the stipulated timeframe, wherein a container status of each of the plurality of FCLs is one of (i) ready-for-pickup and (ii) not-ready-for-pickup, wherein the plurality of factors comprising:
a Port Lead Time factor (PLT_{fact}) scored based on a time required for requesting a carrier to pick up the FCL and time required for the carrier to move from a current location to the port;
a Product Demand fulfilment factor (PD_{shortage}) scored based on a demand shortage for each product in the FCL container to determine if a required demand can be met within a buffer time to a warehouse of the retailer, wherein number of products with the demand shortage and a seasonality of the products contribute to value of the PD_{shortage};
a delivery Route Clearance factor (RC_{fact}) scored by validating traffic, weather, and shortest path from the port to a destination set by the retailer using geographic coordinates of the warehouse;
a destination Distribution Centre (DC) Dock availability factor (DCD_{fact}) scored by validating congestion at a warehouse docking gate;
a destination DC Resource availability factor (DCR_{fact}) scored by predicting absentees among employees for better labor planning and shift allocation at a fulfilment center, machine breakdowns, warehouse outages and capacity constraints; and
a destination Port Demurrage cost factor (PDM_{cost}) scored by calculating a dwell time of a container and multiplying by the number of days over and above an agreed free days at the port of dispatch;
compute a priority score for each of the plurality of FCLs having container status as ready-for-pickup and not-ready-for-pick-up, wherein the priority score is a ratio of integrated individual scores obtained for each the plurality of factors to a total number of FCLs with associated container status; and
generate a ranking list of the plurality of FCLs in the order of the priority scores with container status ready for pickup followed by not-ready-for-pickup, wherein the ranking list is communicated to the retailer to notify a list of carriers for pick up.

5. The system 100 as claimed in claim 4, wherein the one or more hardware processors 104 are configured to determine the container prioritization for each of the plurality of Less than Container Loads (LCLs) as a separate entity by:
dynamically determining the individual scores of the plurality of factors impacting the container prioritization of the plurality of LCLs for the stipulated timeframe, wherein the container status of each of the plurality of LCLs is one of (i) ready-for-pickup and (ii) not-ready-for-pickup;
estimating an additional time taken for deconsolidation of each of the plurality of LCLs at a container freight station (CFS) at the port of dispatch;
computing the priority score for each of the plurality of LCLs having container status as ready-for-pickup and not-ready-for-pick-up, wherein the priority score is the ratio of integrated individual scores obtained for each the plurality of factors to a total number of LCLs with associated container status scaled down by the additional time; and
ranking the list of plurality of LCLs in the order of the priority scores with container status ready for pickup followed by not-ready-for-pickup.

6. The system as claimed in claim 4, wherein predicting the set of inbound containers arriving at the port of dispatch within the stipulated timeframe is based on a plurality of parameters in the supply chain from a time a product order is picked up from a supplier factory gate to a time the product order reaches the port of dispatch.

7. One or more non-transitory machine-readable information storage mediums comprising one or more instructions which when executed by one or more hardware processors cause:
predicting a set of inbound containers arriving at a port of dispatch within a stipulated timeframe for a plurality of products ordered by a retailer, wherein the set of inbound containers comprise a combination of a plurality of Full Container Loads (FCLs) and a plurality of Less than Container Loads (LCLs);
dynamically determining individual scores of a plurality of factors impacting container prioritization of the plurality of FCLs for the stipulated timeframe, wherein a container status of each of the plurality of FCLs is one of (i) ready-for-pickup and (ii) not-ready-for-pickup, wherein the plurality of factors comprising:
a Port Lead Time factor (PLT_{fact}) scored based on a time required for requesting a carrier to pick up the FCL and time required for the carrier to move from a current location to the port;
a Product Demand fulfilment factor (PD_{shortage}) scored based on a demand shortage for each product in the FCL container to determine if a required demand can be met within a buffer time to a warehouse of the retailer, wherein number of products with the demand shortage and a seasonality of the products contribute to value of the PD_{shortage};
a delivery Route Clearance factor (RCfact) scored by validating traffic, weather, and shortest path from the port to a destination set by the retailer using geographic coordinates of the warehouse;
a destination Distribution Centre (DC) Dock availability factor (DCD_{fact}) scored by validating congestion at a warehouse docking gate;
a destination DC Resource availability factor (DCR_{fact}) scored by predicting absentees among employees for better labor planning and shift allocation at a fulfilment center, machine breakdowns, warehouse outages and capacity constraints; and
a destination Port Demurrage cost factor (PDM_{cost}) scored by calculating a dwell time of a container and multiplying by the number of days over and above an agreed free days at the port of dispatch;
computing a priority score for each of the plurality of FCLs having container status as ready-for-pickup and not-ready-for-pick-up, wherein the priority score is a ratio of integrated individual scores obtained for each the plurality of factors to a total number of FCLs with associated container status; and
generating a ranking list of the plurality of FCLs in the order of the priority scores with container status ready for pickup followed by not-ready-for-pickup, wherein the ranking list is communicated to the retailer to notify a list of carriers for pick up.

8. The one or more non-transitory machine-readable information storage mediums of claim 7, wherein determining the container prioritization for each of the plurality of Less than Container Loads (LCLs) as a separate entity, comprising:
dynamically determining the individual scores of the plurality of factors impacting the container prioritization of the plurality of LCLs for the stipulated timeframe, wherein the container status of each of the plurality of LCLs is one of (i) ready-for-pickup and (ii) not-ready-for-pickup;
estimating an additional time taken for deconsolidation of each of the plurality of LCLs at a container freight station (CFS) at the port of dispatch;
computing the priority score for each of the plurality of LCLs having container status as ready-for-pickup and not-ready-for-pick-up, wherein the priority score is the ratio of integrated individual scores obtained for each the plurality of factors to a total number of LCLs with associated container status scaled down by the additional time; and
ranking the list of plurality of LCLs in the order of the priority scores with container status ready for pickup followed by not-ready-for-pickup.

9. The one or more non-transitory machine-readable information storage mediums of claim 7, wherein predicting the set of inbound containers arriving at the port of dispatch within the stipulated timeframe is based on a plurality of parameters in the supply chain from a time a product order is picked up from a supplier factory gate to a time the product order reaches the port of dispatch.
